(19) United States
(12) Patent Application Publication
(10) Pub. No.: US 2026/0057234 A1
(43) Pub. Date: Feb. 26, 2026

(54) METHOD AND DEVICE OF TRAINING GRAPH NEURAL NETWORK

(71) Applicant: SAMSUNG ELECTRONICS CO., LTD., Suwon-si (KR)

(72) Inventors: Yangxu ZHOU, Shaanxi (CN); Dae-In Kang, Suwon-si (KR); Seung-Pyo Cho, Suwon-si (KR); Seung-Woo Lim, Suwon-si (KR); Younggeon Yoo, Suwon-si (KR); Pan Yang, Shaanxi (CN)

(73) Assignee: SAMSUNG ELECTRONICS CO., LTD., Suwon-si (KR)

(21) Appl. No.: 19/361,486

(22) Filed: Oct. 17, 2025

(30) Foreign Application Priority Data
Aug. 26, 2025 (CN) 202511205912.7

(51) Int. Cl. G06N 3/08; G06T 1/20

(52) U.S. Cl. CPC G06N 3/08; G06T 1/20

(57) ABSTRACT

A method and a device for training a graph neural network are provided. The method may be performed by a graphics processing unit (GPU), and may include determining at least one batch of training data; transmitting batch information corresponding to the determined at least one batch to at least one memory expansion device, so that the at least one memory expansion device acquires feature data for one or more data blocks of the at least one batch based on the batch information, receiving the feature data from the at least one memory expansion device; and training the graph neural network based on the feature data.

### CROSS-REFERENCE TO RELATED APPLICATION

This application claims priority from Chinese Patent Application No. 202511205912.7, filed on Aug. 26, 2025, in the China National Intellectual Property Administration, the disclosure of which is incorporated herein by reference in its entirety.

### TECHNICAL FIELD

The present disclosure relates to a field of computer technology. More particularly, the present disclosure relates to a method and device of training a graph neural network.

### BACKGROUND

Graph neural networks (GNNs), as a branch of deep learning, has recently achieved convincing performance on graph data and have been successfully applied to recommendation systems of e-commerce platforms, social network mining, drug discovery, and fraud detection. The training of graph neural networks involves a large-scale graph with billions of nodes and edges, which leads to the graphics processing unit (GPU) not having enough video memory and memory to accommodate such a large amount of data. A common practice to solve this problem is to use only some of the neighbors to generate subgraphs for training. This method reduces computational and memory pressure while ensuring high accuracy.

Sampling-based graph neural network training consists of three main phases: a sampling phase, a feature extraction phase and a training phase. In the sampling phase, an input graph is sampled based on a user-defined algorithm which takes into account the topological data of the graph and generates a list of sampled nodes. Next, features of the sampled nodes are extracted into a separate buffer. Finally, in the training phase, the training is performed by using the extracted features.

Putting all the training data into the GPU is one of the fastest training methods. However, considering that the size of the graph grows continuously in a real application, it is impractical to load and train the entire graph on the GPU for graph neural network training due to the limited memory capacity of the GPU. Therefore, most of the methods used in the field are disk-based systems. The disk-based systems use the same workflow as in-memory training systems. However, in the traditional scheme, during the training phase, most of the time is consumed in reading from the disk and processing by the central processing unit (CPU), while the GPU spends most of the time waiting for the training data, which results in slow training speed of the graph neural network.

### SUMMARY

One or more embodiments of the present disclosure provide a method and device of training a graph neural network to reduce the amount of time the GPU waits for training data, thereby improving a training speed of the graph neural network.

According to an aspect of the present disclosure, a method of training a graph neural network, performed by a graphics processing unit (GPU), may include: determining at least one batch of training data; transmitting batch information corresponding to the determined at least one batch to at least one memory expansion device, so that the at least one memory expansion device acquires feature data for one or more data blocks of the at least one batch based on the batch information; receiving the feature data from the at least one memory expansion device; and training the graph neural network based on the feature data.

According to an aspect of the present disclosure, there is provided a non-transitory computer-readable storage medium storing one or more instructions that, when executed by at least one processor, implements the method of training the graph neural network, performed by the GPU.

According to an aspect of the present disclosure, a method of training a graph neural network, performed by a memory expansion device, may include: receiving batch information indicating at least one batch of training data transmitted a graphics processing unit (GPU); determining at least one corresponding batch among a plurality of batches of training data based on the batch information; acquiring feature data of the at least one corresponding batch; and transmitting the feature data to the GPU so that the GPU trains the graph neural network using the feature data.

According to an aspect of the present disclosure, there is provided a non-transitory computer-readable storage medium storing one or more instructions that, when executed by at least one processor, implements the method of training the graph neural network, performed by the memory expansion device.

According to an aspect of the present disclosure, there is provided a device of training a graph neural network, the device including at least one processor configured to: determine at least one batch of training data; transmit batch information corresponding to the determined at least one batch to at least one memory expansion device, so that the at least one memory expansion device acquires feature data for one or more data blocks of the at least one batch based on the batch information; receive the feature data from the at least one memory expansion device; and train the graph neural network based on the feature data.

According to an aspect of the present disclosure, there is provided a device of training a graph neural network, the device including at least one processor configured to: receive batch information indicating at least one batch of training data transmitted by a graphics processing unit (GPU); determine at least one corresponding batch among a plurality of batches of training data based on the batch information; acquire feature data of the at least one corresponding batch; and transmit the feature data to the GPU so that the GPU trains the graph neural network using the feature data.

### BRIEF DESCRIPTION OF DRAWINGS

The above and other purposes and features of exemplary embodiments of the present disclosure will become clearer through the following description in conjunction with the drawings that exemplarily illustrate embodiments, wherein:

FIG. 1 illustrates a flowchart of a method of training a graph neural network according to an exemplary embodiment of the present disclosure;

FIG. 2 illustrates a schematic diagram of functions of a graphics processing unit (GPU) according to an exemplary embodiment of the present disclosure;

FIG. 3 illustrates a flowchart of a method of training a graph neural network according to an exemplary embodiment of the present disclosure;

FIG. 4 illustrates a schematic diagram of functions of a memory expansion device according to an exemplary embodiment of the present disclosure;

FIG. 5 illustrates a schematic diagram of a data perfecting function and a data caching policy function of a memory expansion device according to an exemplary embodiment of the present disclosure;

FIG. 6 illustrates a block diagram of a device of training a graph neural network according to an exemplary embodiment of the present disclosure;

FIG. 7 illustrates a block diagram of a device of training a graph neural network according to an exemplary embodiment of the present disclosure; and

FIG. 8 illustrates a schematic diagram of a computing device according to an exemplary embodiment of the present disclosure.

### DETAILED DESCRIPTION

Reference will now be made in detail to an exemplary embodiment of the present disclosure, examples of which are illustrated in the drawings, wherein the same reference numerals always refer to the same members. Embodiments are described below in order to explain the present disclosure by referring to the drawings.

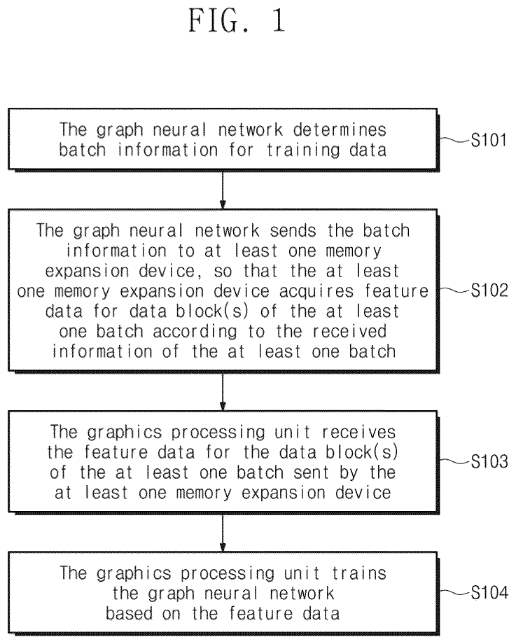

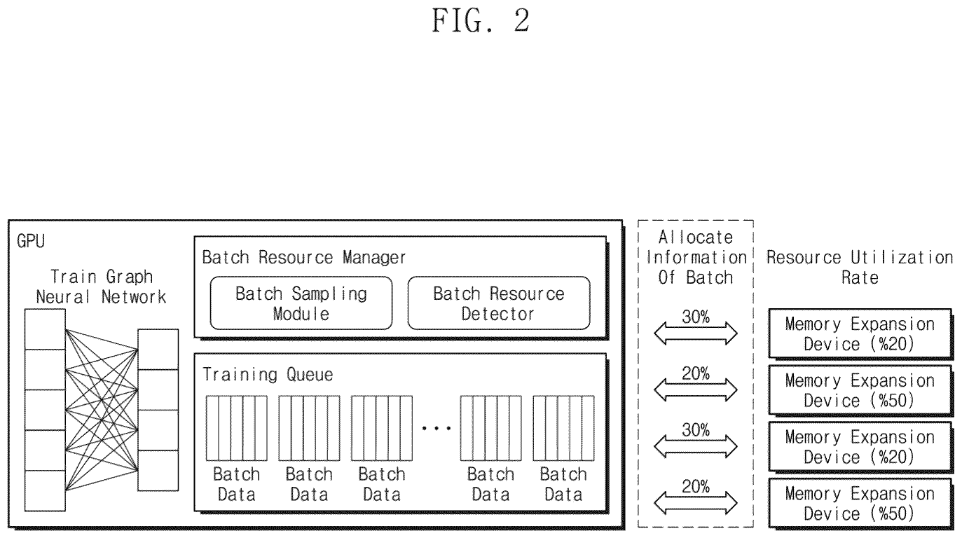

FIG. 1 illustrates a flowchart of a method of training a graph neural network according to one or more example embodiments of the present disclosure. FIG. 2 illustrates a schematic diagram of functions of a graphics processing unit (GPU) according to one or more example embodiments of the present disclosure. The method of training a graph neural network may be performed by one or more processors (e.g., a GPU).

Referring to FIG. 1, in operation S101, the graph neural network determines batch information for training data. Herein, the training data may include a plurality of batches, the batch information includes information of at least one batch of the training data. For example, the GPU determines the batch information of the training data using a sampling algorithm executed on a GPU. Since the sampling process involves relatively small data and is computationally efficient, it may be effectively performed on the GPU. For example, the batch information may include Identities (IDs) of a plurality (e.g., N) of batches. The batch IDs may be organized in a list format, representing a selected subset of all training data batches.

For example, as shown in FIG. 2, the GPU may include a batch resource manager, which may include a batch sampling module (e.g., a batch ID sampling calculation module). The GPU may run a random sampling algorithm through the batch sampling module to generate batch information (e.g., a list of batch IDs) covering all batches. In some embodiments, the batch information may contain only the ID information, which requires minimal memory. Given this lightweight data structure, the GPU's graphics memory may be sufficient for storage, the processing speed is enhanced by performing the computation on the GPU.

In one or more example embodiments of the present disclosure, the determining of the batch information for the training data, may include: acquiring an identity for each of the at least one batch, wherein the identity may include a unique identifier and data block index(es) of a batch; and determining the identity as at least a portion of the batch information.

In operation S102, the graph neural network sends the batch information (e.g., batch IDs) to at least one memory expansion device, so that the at least one memory expansion device acquires feature data for data block(s) of the at least one batch according to the received information of the at least one batch. Performing the extraction of the feature data by the memory expansion unit may reduce data movement. A plurality of memory expansion devices may perform feature data extraction in parallel to speed up the training process of the GPU. The memory expansion device may be implemented using one or more of, or any combination of, processing components such as a general-purpose processor (e.g., a central processing unit (CPU)); a specialized lightweight processor (e.g., a data processing unit (DPU) or auxiliary processor); a field-programmable gate array (FPGA); an application-specific integrated circuit (ASIC); a processing-in-memory (PIM) module; or a GPU-accessible compute engine, each of which may be integrated with or operating alongside memory, within the memory expansion device.

In one or more example embodiments of the present disclosure, the at least one batch may include a plurality of batches and the at least one memory expansion device may include a plurality of memory expansion devices, wherein the sending of the batch information to the at least one memory expansion device may include: sending information of corresponding batch(es) among the information of the plurality of batches to corresponding memory expansion devices among the plurality of memory expansion devices, respectively, thereby transferring the extraction of the feature data to the plurality of memory expansion devices for execution, and thereby allowing the extraction of the feature data to be performed in parallel by the plurality of memory expansion devices.

In one or more example embodiments of the present disclosure, the process of sending batch information to corresponding memory expansion devices among the plurality of memory expansion devices, respectively, may include allocation based on the current workload of each memory expansion device. For example, the method may include: acquiring a resource utilization rate for each of the plurality of memory expansion devices; determining a quantity of batch information sent to each of the plurality of memory expansion devices based on the resource utilization rate; determining an allocation result for allocating the information of the plurality of batches to the plurality of memory expansion devices based on the quantity; and sending the information of the plurality of batches based on the allocation result, thereby improving the effectiveness of information allocation.

In the process of acquiring the resource utilization rate, the resource utilization rate may refer to a metric that indicates the current workload or capacity usage of a memory expansion device. For example, it may reflect the percentage of processing capability or memory bandwidth currently in use. A memory expansion device operating at 80% utilization is considered more heavily loaded than one operating at 40%.

In the process of determining the quantity of batch information, the quantity may refer to the number of batches (or the amount of data) allocated to each memory expansion device. For instance, a memory expansion device with lower utilization (e.g., 30%) may be assigned 5 batches, while a memory expansion device with higher utilization (e.g., 70%) may be assigned only 2 batches, thereby helping to balance the workload across memory expansion devices.

In the process of determining the allocation result, the allocation result may refer to a mapping that assigns specific batch information (e.g., batch IDs or feature extraction tasks) to specific memory expansion devices to optimize overall processing efficiency across all available memory expansion devices.

For example, as shown in FIG. 2, the batch resource manager included in the GPU may also include a batch resource detector. The batch resource detector is used to detect the resource utilization rate of the CPU and the memory expansion device, to decide information (e.g., a list of batch IDs) of how many batches is to be sent to each of the memory expansion devices or the CPU according to their resource utilization rate, so as to send the allocated information (e.g., a list of batch IDs) of the batches to the corresponding memory expansion device or the CPU according to the decision, and then feature data (e.g., batch data) for the data block(s) of the corresponding batch(es) is generated by the corresponding memory expansion device or the CPU. Therefore, the GPU may determine the quantity or ratio of the information of the batches (e.g., 30%, 20%, 50%, etc. in FIG. 2) sent to each of the plurality of memory expansion devices based on the resource utilization rate by the batch resource detector included in the batch resource manager. Thereafter, the GPU may distribute the information (e.g., ID lists) of the plurality of batches of the training data according to the determined quantity or ratio, sends the information (e.g., a ID list) of each of the plurality of batches to the corresponding CPU or the memory expansion device (e.g., CMM-HC device). The memory expansion device may be implemented using various hardware types, including a Compute Express Link (CXL) Memory Module-Hybrid Compute (CMM-HC) device, which integrates both memory (e.g., dynamic random access memory (DRAM), NOT AND-type (NAND) flash memory, and/or solid-state drive (SSD)) and onboard compute capabilities to perform data processing tasks such as feature extraction.

In one or more example embodiments of the present disclosure, the memory expansion device may include a first memory, a second memory, and a field programmable gate array. Herein, the field programmable gate array may be connected to the first memory and the second memory, the first memory may be connected to the second memory, and a read speed of the first memory may be greater than a read speed of the second memory. For example, the first memory may include a DRAM, and the second memory may include a NAND flash. For example, the first memory may be a DRAM, and the second memory may be a NAND flash.

For example, the memory expansion device may be a device with a smart solid-state drive (SSD) and a Compute Express Link (CXL) interface. The memory expansion device may integrate the DRAM and the NAND flash and support the CXL interface, thereby providing a cost-effective memory expansion device. The memory expansion device (e.g., CMM-HC) may provide a byte-level data access as well as terabyte (TeraByte, or TB)-level capacity, and support that data is prefetched from the NAND flash and cached to the DRAM. The memory expansion device (e.g., CMM-HC) may also have a built-in computation hardware, which may provide a near-memory computation capability to accelerate applications.

In operation S103, the GPU receives the feature data for the data block(s) of the at least one batch sent by the at least one memory expansion device. In one or more example embodiments of the present disclosure, in a case where the at least one batch include a plurality of batches and the at least one memory expansion device include a plurality of memory expansion devices, the GPU receives the feature data for the data block(s) of corresponding batch(es) sent by each of the plurality of memory expansion devices, to obtain the feature data for the data block(s) of the at least one batch.

In operation S104, the GPU trains the graph neural network based on the feature data.

In one or more example embodiments of the present disclosure, the training of the graph neural network based on the feature data may include: sequentially placing the feature data for a data block of each of the at least one batch into a training queue (for example, the training queue in FIG. 2) based on the identity; and sequentially acquiring corresponding feature data for training the graph neural network based on sequence in the training queue, thereby avoiding waiting for the extraction of the feature data and thus increasing the training speed of the graph neural network.

For example, as shown in FIG. 2, a training queue may be included in the GPU. For example, an order of the feature data in the training queue (e.g., the training queue in FIG. 2) for the data block(s) of the corresponding batch(es) may be determined based on the order of the IDs. When training the graph neural network, the feature data is acquired in the order of the feature data in the training queue.

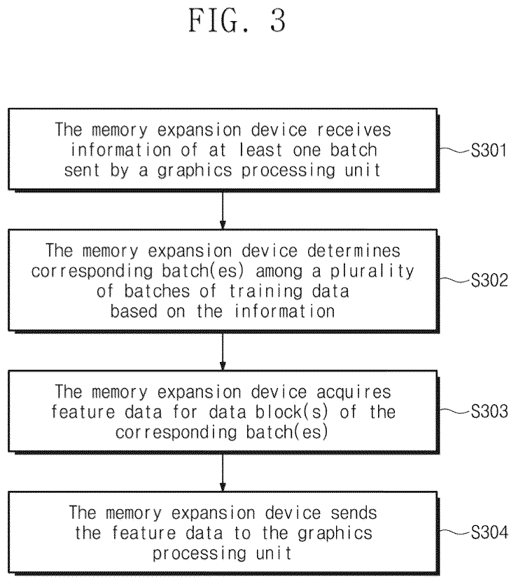

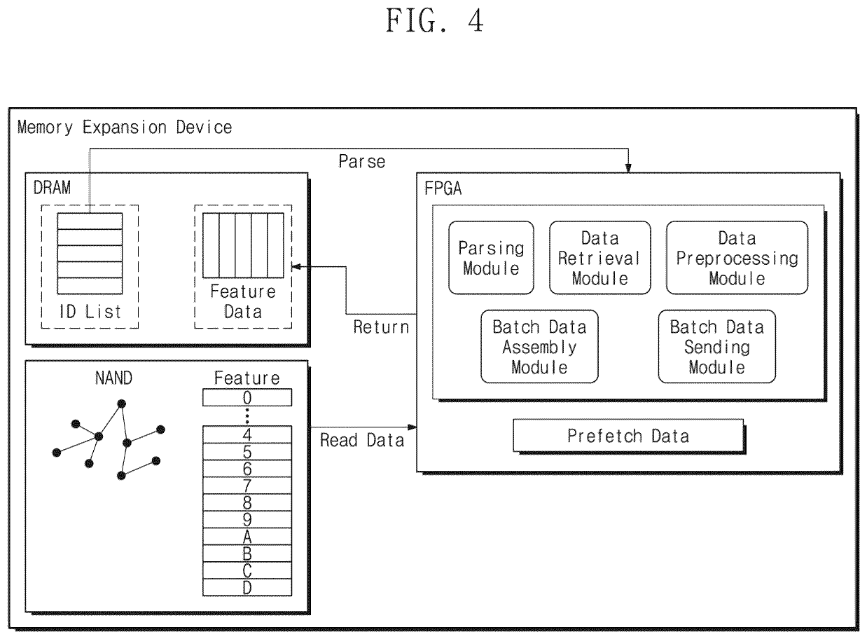

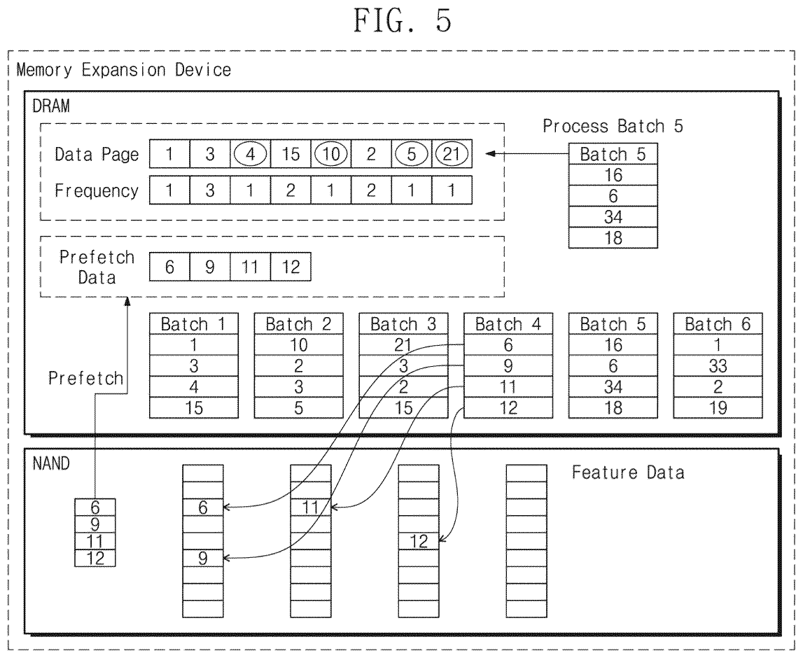

FIG. 3 illustrates a flowchart of a method of training a graph neural network according to one or more example embodiments of the present disclosure. FIG. 4 illustrates a schematic diagram of functions of a memory expansion device according to one or more example embodiments of the present disclosure. FIG. 5 illustrates a schematic diagram of a data perfecting function and a data caching policy function of a memory expansion device according to one or more example embodiments of the present disclosure. The method of training the graph neural network in FIG. 3 may be performed by a memory expansion device. When there are a plurality of memory expansion devices, each of the plurality of memory expansion devices may separately/parallelly perform the method of training the graph neural network in FIG. 3.

Referring to FIG. 3, in operation S301, the memory expansion device receives information of at least one batch sent by a GPU. Here, the memory expansion device may receive information of a plurality of batches (for example, a plurality of batch ID lists, wherein information of each batch is indicated by a batch ID list).

In one or more example embodiments of the present disclosure, the memory expansion device may include a first memory, a second memory, and a field programmable gate array (FPGA). The method of training the graph neural network in FIG. 3 may be performed by the field programmable gate array included in the memory expansion device.

In one or more example embodiments of the present disclosure, the field programmable gate array may be connected to the first memory and the second memory, the first memory may be connected to the second memory, and a read speed of the first memory may be greater than a read speed of the second memory.

In one or more example embodiments of the present disclosure, the first memory may include a DRAM, and the second memory may include a NAND flash.

For example, the memory expansion device may be a device having a smart SSD and a Compute Express Link (CXL) interface. The memory expansion device may integrate the DRAM and the NAND flash and support the CXL interface, thereby providing a cost-effective memory expansion device. The memory expansion device (e.g., CMM-HC) may provide a byte-level data access as well as a terabyte (TeraByte (TB))-level capacity and support prefetching of data caches from the NAND flash to the DRAM. The memory expansion device (e.g., CMM-HC) may also have a built-in computation hardware, which may provide a near-memory computation capability to accelerate applications.

In operation S302, the memory expansion device determines corresponding batch(es) among a plurality of batches of training data based on the information of the at least one batch.

In one or more example embodiments of the present disclosure, the determining of corresponding batch(es) of the plurality of batches of training data based on the information of the at least one batch may include: determining an identity for each of the corresponding batch(es) based on the information of the at least one batch, wherein the identity may include a unique identifier and data block index(es) of a batch; and determining the corresponding batch(es) based on the unique identifier, thereby enabling the parsing of information of the at least one batch sent by the GPU.

For example, the field programmable gate array included in the memory expansion device may parse (e.g., via the parsing module in FIG. 4) the received information (e.g., a batch ID list) of each batch into single pieces of information (e.g., batch ID). Each piece of information (e.g., a batch ID) includes a unique identifier and data block index(es) of the batch (e.g., a graphics instance). In addition, each piece of information (e.g., the batch ID) may include other metadata of the batch (e.g., a graphics instance). The field programmable gate array included in the memory expansion device may use a specialized logic circuitry to parse the information of the batch (e.g., the batch ID list), e.g., quickly retrieve the data block corresponding to the batch or the feature data for the data block corresponding to the batch by the data retrieval module in FIG. 4 using a lookup table or content-addressable memory.

In operation S303, the memory expansion device acquires feature data for data block(s) of the corresponding batch(es).

In one or more example embodiments of the present disclosure, the acquiring of the feature data for the data block(s) of the corresponding batch(es) may include: extracting the feature data for the data block(s) of the corresponding batch(es) from the second memory to the first memory based on the data block index(es). For example, in a case where the feature data for the data block(s) of the corresponding batch(es) is not prefetched from the second memory to the first memory, the field programmable gate array included in the memory expansion device may, based on the data block index, fetch the feature data for the data block(s) of the corresponding batch(es) from the second memory to the first memory.

In one or more example embodiments of the present disclosure, the extracting of the feature data for the data block(s) of the corresponding batch(es) from the second memory to the first memory based on the data block index(es) may include: determining the data block(s) of the corresponding batch(es) from the second memory based on the data block index(es); and extracting feature data for the data block(s) of the corresponding batch(es) to the first memory. For example, in a case where the feature data for the data block(s) of the corresponding batch(es) is not prefetched from the second memory to the first memory, the field programmable gate array included in the memory expansion device may determine the data block(s) of the corresponding batch(es) from the second memory based on the data block index(es); and fetch the feature data for the data block(s) of the corresponding batch(es) to the first memory. For example, the data block(s) may be stored in a buffer or cache of the field programmable gate array included in the memory expansion device so as to be further processed. The field programmable gate array included in the memory expansion device may access the second memory (e.g., a memory or a storage unit) using a specialized interface.

In addition, the memory expansion device in the present disclosure may have a data prefetching function. For example, as shown in FIGS. 4 and 5, the memory expansion device may prefetch, according to data block index(es) included in the information of a batch (e.g., batch 4 in FIG. 5) next to a batch which is being used (e.g., batch 3 in FIG. 5), feature data (6, 9, 11, 12) for data block(s) of the next batch (e.g., batch 4 in FIG. 5) from the second memory into the first memory.

In one or more example embodiments of the present disclosure, the acquiring of the feature data for the data block(s) of the corresponding batch(es) may include: based on the data block index(es), acquiring from the first memory, the feature data for the data block(s) of the corresponding batch(es) prefetched from the second memory to the first memory, thereby increasing a reading speed of the feature data due to the reading speed of the first memory being greater than the reading speed of the second memory. For example, in a case where the feature data for the data block(s) of the corresponding batch(es) has been prefetched from the second memory to the first memory, the field programmable gate array included in the memory expansion device may acquire from the first memory, based on the data block index(es), the feature data for the data block(s) of the corresponding batch(es) prefetched from the second memory to the first memory.

In operation S304, the memory expansion device sends the feature data to the GPU, so that the GPU trains the graph neural network using the feature data. Since the data sent to the GPU is the data required for the training of the GPU, sending or transmission of redundant data is reduced and peripheral component interconnect express (PCIe) data traffic is reduced.

In one or more example embodiments of the present disclosure, the sending of the feature data to the GPU may include: performing a preprocessing operation on the feature data extracted to the first memory; and sending the feature data after the preprocessing from the first memory to the GPU, thereby improving the efficiency and effectiveness of the sending.

For example, the field programmable gate array included in the memory expansion device may perform necessary preprocessing operations on the feature data. The preprocessing operations may be, for example, but are not limited to, data format conversion, data normalization. For example, the field programmable gate array included in the memory expansion device may perform the preprocessing operations using a specialized Digital Signal Processing (DSP) unit or a fixed-point number arithmetic unit (e.g., the data preprocessing module in FIG. 4). For example, the preprocessing operations may be configurable, e.g., using a programmable logic of the field programmable gate array included in the memory expansion device to implement different preprocessing algorithms.

In addition, the field programmable gate array included in the memory expansion device may assemble the preprocessed feature data into batch data or batch data blocks. The batch data blocks are the input data required by a computation unit to perform the computation. The field programmable gate array included in the memory expansion device may use a specialized data arrangement unit (e.g., the batch data assembly module in FIG. 4) to assemble the feature data into the batch data or the batch data blocks. Afterwards, the batch data or the batch data blocks are transferred (e.g., by the batch data sending module in FIG. 4) from a first memory (e.g., DRAM) included in the memory expansion device to the GPU.

In addition, the memory expansion device in the present disclosure may have a data caching policy function (e.g., a cache replacement algorithm function, a cache replacement algorithm function based on future batches).

In one or more example embodiments of the present disclosure, the extracting of the feature data for the data block(s) of the corresponding batch(es) from the second memory into the first memory may include: replacing feature data in the first memory that meets a data replacement condition using the feature data for the data block(s) of the corresponding batch(es), thereby increasing the usefulness of the feature data in the first memory.

For example, as shown in FIG. 5, when extracting the feature data of the data block of the batch 5, the memory expansion device may sequentially replace feature data 4, 10, 5, and 21, which have a utilization rate of 1 and will not be used in the future, with the feature data of the data block of the batch 5. Specifically, as shown in FIG. 5, the memory expansion device may sequentially place the feature data 16, 6, 34, and 18 at the locations of the original feature data 4, 10, 5, and 21.

In one or more example embodiments of the present disclosure, the data replacement condition may include at least one of following conditions: a utilization rate being below a predetermined value, a storage time exceeding a threshold, and the feature data will not be used for a predetermined period of time. The cache replacement policy prioritizes replacing old data, seldom-used data, and data which will not be used in future batches.

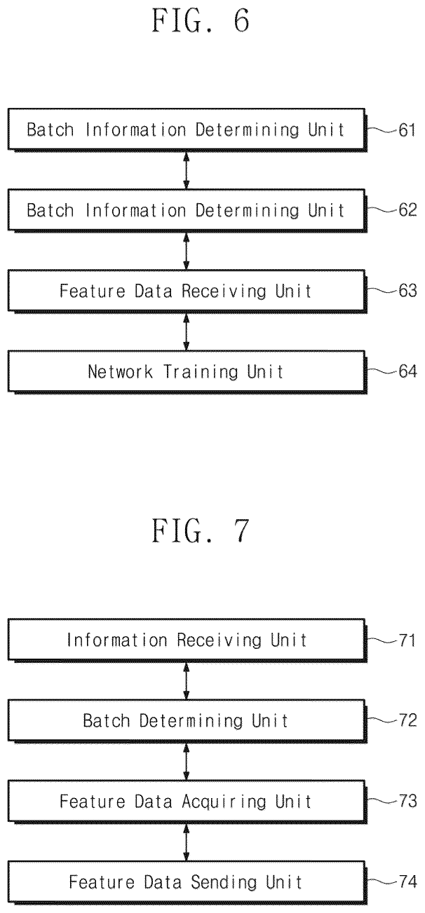

The method of training a graph neural network according to one or more example embodiments of the present disclosure has been described above in conjunction with FIG. 1 to FIG. 5. Hereinafter, a device of training a graph neural network and the units thereof according to the exemplary embodiments of the present disclosure will be described with reference to FIG. 6 and FIG. 7.

FIG. 6 illustrates a block diagram of a device of training a graph neural network according to one or more example embodiments of the present disclosure. The device of training a graph neural network in FIG. 6 may also be referred to as a GPU.

Referring to FIG. 6, the device of training a graph neural network includes a batch information determining unit 61, a batch information sending unit 62, a feature data receiving unit 63, and a network training unit 64.

The batch information determining unit 61 is configured to determine batch information for training data, wherein the batch information includes information of at least one batch of the training data.

In one or more example embodiments of the present disclosure, the batch information determining unit 61 may be configured to: acquire an identity for each of the at least one batch, wherein the identity may include a unique identifier and data block index(es) of a batch; and determine the identity as at least a portion of the batch information.

In one or more example embodiments of the present disclosure, the at least one batch may include a plurality of batches and the at least one memory expansion device may include a plurality of memory expansion devices. In this case, the batch information determining unit 61 may be configured to: send information of corresponding batch(es) among the information of the plurality of batches to corresponding memory expansion devices among the plurality of memory expansion devices, respectively.

The batch information sending unit 62 is configured to send the batch information to at least one memory expansion device, so that the at least one memory expansion device acquires feature data for data block(s) of the at least one batch according to the received information of the at least one batch. Performing the extraction of the feature data by the memory expansion device may reduce data movement. A plurality of memory expansion devices may perform feature data extraction in parallel to speed up the training process of the GPU.

In one or more example embodiments of the present disclosure, the batch information sending unit 62 may be configured to: acquire a resource utilization rate for each of the plurality of memory expansion devices; determine a quantity of information of batch sent to each of the plurality of memory expansion devices based on the resource utilization rate; determine an allocation result for allocating the information of the plurality of batches to the plurality of memory expansion devices based on the quantity; and send the information of the plurality of batches based on the allocation result.

In one or more example embodiments of the present disclosure, the memory expansion device may include a first memory, a second memory, and a field programmable gate array. Herein, the field programmable gate array may be connected to the first memory and the second memory, the first memory may be connected to the second memory, and a read speed of the first memory may be greater than a read speed of the second memory. For example, the first memory may include a DRAM, and the second memory may include a NAND flash. For example, the first memory may be a DRAM, and the second memory may be a NAND flash.

The feature data receiving unit 63 is configured to receive the feature data for the data block(s) of the at least one batch sent by the at least one memory expansion device.

In one or more example embodiments of the present disclosure, in a case where the at least one batch include a plurality of batches and the at least one memory expansion device include a plurality of memory expansion devices, the feature data receiving unit 63 may be configured to receive the feature data for the data block(s) of corresponding batch(es) sent by each of the plurality of memory expansion devices, to obtain the feature data for the data block(s) of the at least one batch.

The network training unit 64 is configured to train the graph neural network based on the feature data.

In one or more example embodiments of the present disclosure, the network training unit 64 may be configured to: sequentially place the feature data for a data block of each of the at least one batch into a training queue based on the identity; and sequentially acquire corresponding feature data for training the graph neural network based on sequence in the training queue.

FIG. 7 illustrates a block diagram of a device of training a graph neural network according to one or more example embodiments of the present disclosure. The device of training a graph neural network in FIG. 7 may also be referred to as a memory expansion device.

Referring to FIG. 7, the device of training a graph neural network includes an information receiving unit 71, a batch determining unit 72, a feature data acquiring unit 73, and a feature data sending unit 74.

The information receiving unit 71 is configured to receive information of at least one batch sent by a GPU. Herein, the information receiving unit 71 may receive information of a plurality of batches (e.g., a plurality of batch ID lists, wherein the information of each batch is represented by a batch ID list).

In one or more example embodiments of the present disclosure, the device of training a graph neural network may further include a first memory and a second memory.

In one or more example embodiments of the present disclosure, the first memory may include a DRAM, and the second memory may include a NAND flash.

The batch determining unit 72 is configured to determine corresponding batch(es) among a plurality of batches of training data based on the information of the at least one batch.

In one or more example embodiments of the present disclosure, the batch determining unit 72 may be configured to: determine an identity for each of the corresponding batch(es) based on the information of the at least one batch, wherein the identity may include a unique identifier and data block index(es) of a batch; and determine the corresponding batch(es) based on the unique identifier.

The feature data acquiring unit 73 is configured to acquire feature data for data block(s) of the corresponding batch(es).

In one or more example embodiments of the present disclosure, the feature data acquiring unit 73 may be configured to: extract the feature data for the data block(s) of the corresponding batch(es) from the second memory to the first memory based on the data block index(es).

In one or more example embodiments of the present disclosure, the feature data acquiring unit 73 may be configured to: determine the data block(s) of the corresponding batch(es) from the second memory based on the data block index(es); and extract feature data for the data block(s) of the corresponding batch(es) to the first memory.

In addition, the feature data acquiring unit 73 in the present disclosure may have a data prefetching function.

In one or more example embodiments of the present disclosure, the feature data acquiring unit 73 may be configured to: based on the data block index(es), acquire from the first memory, the feature data for the data block(s) of the corresponding batch(es) prefetched from the second memory to the first memory.

The feature data sending unit 74 is configured to send the feature data to the GPU, so that the GPU trains the graph neural network using the feature data.

In one or more example embodiments of the present disclosure, the feature data sending unit 74 may be configured to: perform a preprocessing operation on the feature data extracted to the first memory; and send the feature data after the preprocessing from the first memory to the GPU.

In one or more example embodiments of the present disclosure, the feature data sending unit 74 may be configured to: replace feature data in the first memory that meets a data replacement condition using the feature data for the data block(s) of the corresponding batch(es).

In one or more example embodiments of the present disclosure, the data replacement condition may include at least one of following conditions: a utilization rate being below a predetermined value, a storage time exceeding a threshold, and the feature data will not be used for a predetermined period of time.

In one or more example embodiments of the present disclosure, the information receiving unit 71, the batch determining unit 72, the feature data acquiring unit 73 and the feature data sending unit 74 may be included in the field programmable gate array, or may be implemented by the field programmable gate array.

In one or more example embodiments of the present disclosure, the field programmable gate array may be connected to the first memory and the second memory, the first memory may be connected to the second memory, and a read speed of the first memory may be greater than a read speed of the second memory.

In addition, according to one or more example embodiments of the present disclosure, there also provides a computer-readable storage medium having a computer program stored thereon, and when the computer program is executed, the method of training a graph neural network according to one or more example embodiments of the present disclosure is implemented.

In one or more example embodiments of the present disclosure, the computer-readable storage medium may carry one or more programs that, when executed, may implement the following steps: determining batch information for training data, wherein the batch information includes information of at least one batch of the training data; sending the batch information to at least one memory expansion device, so that the at least one memory expansion device acquires feature data for data block(s) of the at least one batch according to the received information of the at least one batch; receiving the feature data for the data block(s) of the at least one batch sent by the at least one memory expansion device; and training the graph neural network based on the feature data, thereby improving the training speed of the graph neural network, while maintaining the training accuracy of the graph neural network.

In one or more example embodiments of the present disclosure, the computer-readable storage medium may carry one or more programs that, when executed, may implement the following steps: receiving information of at least one batch sent by a GPU; determining corresponding batch(es) among a plurality of batches of training data based on the information of the at least one batch; acquiring feature data for data block(s) of the corresponding batch(es); and sending the feature data to the GPU, so that the GPU trains the graph neural network using the feature data, thereby improving the training speed of the graph neural network, while maintaining the training accuracy of the graph neural network.

The computer-readable storage medium may be, for example, but not limited to, an electrical, magnetic, optical, electromagnetic, infrared, or semiconductor system, apparatus or device, or any combination of the above. More specific examples of computer-readable storage medium may include, but are not limited to: electrical connections with one or more wires, portable computer disks, hard disks, random access memory (RAM), read only memory (ROM), erasable programmable read only memory (EPROM or flash), optical fiber, portable compact disk read only memory (CD-ROM), optical storage devices, magnetic storage devices, or any suitable combination of the above. In one or more example embodiments of the present disclosure, a computer-readable storage medium may be any tangible medium that contains or stores a computer program that may be used by or in conjunction with an instruction execution system, apparatus, or device. The computer program contained on the computer-readable storage medium may be transmitted using any appropriate medium, including but not limited to wire, fiber optic cable, RF (radio frequency), etc., or any suitable combination of the above. The computer-readable storage medium may be included in any device, and it may also exist alone without being incorporated into the device.

In addition, according to one or more example embodiments of the present disclosure, there also provides a computer program product, wherein instructions in the computer program product may be executed by a processor of the computer device to complete the method of training a graph neural network according to one or more example embodiments of the present disclosure.

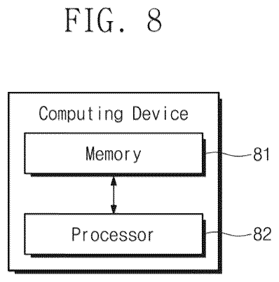

The device of training a graph neural network according to the exemplary embodiments of the present disclosure has been described above in conjunction with FIG. 6 to FIG. 7. Next, a computing device according to one or more example embodiments of the present disclosure will be described in conjunction with to FIG. 8.

FIG. 8 illustrates a schematic diagram of a computing device according to one or more example embodiments of the present disclosure.

Referring to FIG. 8, a computing device 8 according to one or more example embodiments of the present disclosure may include a memory 81 and a processor 82, and the memory 81 stores a computer program. that, when executed by the processor 82, implements the fingerprint matching method or the acquiring method of fingerprint template information according to one or more example embodiments of the present disclosure.

In one or more example embodiments of the present disclosure, when the computer program is executed by the processor 82, the following steps may be implemented: determining batch information for training data, wherein the batch information includes information of at least one batch of the training data; sending the batch information to at least one memory expansion device, so that the at least one memory expansion device acquires feature data for data block(s) of the at least one batch according to the received information of the at least one batch; receiving the feature data for the data block(s) of the at least one batch sent by the at least one memory expansion device; and training the graph neural network based on the feature data, thereby improving the training speed of the graph neural network, while maintaining the training accuracy of the graph neural network.

In one or more example embodiments of the present disclosure, when the computer program is executed by the processor 82, the following steps may be implemented: receiving information of at least one batch sent by a GPU; determining corresponding batch(es) among a plurality of batches of training data based on the information of the at least one batch; acquiring feature data for data block(s) of the corresponding batch(es); and sending the feature data to the GPU, so that the GPU trains the graph neural network using the feature data, thereby improving the training speed of the graph neural network, while maintaining the training accuracy of the graph neural network.

The computing device in one or more example embodiments of the present disclosure may include, but are not limited to, devices such as a mobile telephone, a laptop, a PDA (personal digital assistant), a PAD (tablet computer), a desktop computer, etc. The computing device shown in FIG. 8 is only an example, and should not impose any limitation on the function and scope of use of embodiments of the present disclosure.

The method and device, of training a graph neural network according to one or more example embodiments of the present disclosure have been described above with reference to FIGS. 1 to 8. However, it should be understood: the device of training a graph neural network and the unit thereof, shown in FIG. 6 to FIG. 7 may be respectively configured as software, hardware, firmware or any combination thereof to perform specific functions, and the computing device shown in FIG. 8 is not limited to including the above shown components, but some components may be added or deleted according to needs, and the above components may also be combined.

In one or more embodiments, a method of training a graph neural network, performed by a graphics processing unit (GPU), may include: determining at least one batch of training data; transmitting batch information corresponding to the determined at least one batch to at least one memory expansion device, so that the at least one memory expansion device acquires feature data for one or more data blocks of the at least one batch based on the batch information; receiving the feature data from the at least one memory expansion device; and training the graph neural network based on the feature data.

The method may include: acquiring an identity that comprises an identifier and a data block index corresponding to the at least one batch; and generating the batch information including the identifier and the data block index associated with the at least one batch.

The at least one batch is included in a plurality of batches, and the at least one memory expansion device is included in a plurality of memory expansion devices, and wherein the transmitting of the batch information may include: transmitting information of corresponding batches among the plurality of batches to corresponding memory expansion devices among the plurality of memory expansion devices, respectively.

The transmitting of the information of the corresponding batches may include: acquiring resource utilization rates of the plurality of memory expansion devices, respectively; determining a data quantity of the at least one batch transmitted to the plurality of memory expansion devices based on the resource utilization rates; determining an allocation result for allocating the plurality of batches to the plurality of memory expansion devices based on the data quantity; and transmitting the plurality of batches based on the allocation result.

The training of the graph neural network may include: sequentially placing the feature data into a training queue based on the identity; and training the graph neural network based on a sequence of the feature data in the training queue.

The memory expansion device may include a first memory, a second memory, and a field programmable gate array.

In one or more embodiments, there is provided a non-transitory computer-readable storage medium storing one or more instructions that, when executed by at least one processor, implements the method of training the graph neural network, performed by the GPU.

In one or more embodiments, a method of training a graph neural network, performed by a memory expansion device, may include: receiving batch information indicating at least one batch of training data transmitted a graphics processing unit (GPU); determining at least one corresponding batch among a plurality of batches of training data based on the batch information; acquiring feature data of the at least one corresponding batch; and transmitting the feature data to the GPU so that the GPU trains the graph neural network using the feature data.

The determining of the at least one corresponding batch may include: determining an identity for each of the at least one corresponding batch based on the batch information, wherein the identity comprises an identifier and a data block index corresponding to the at least one batch; and determining the at least one corresponding batch based on the identifier.

The memory expansion device may include a first memory, a second memory, and a field programmable gate array.

The field programmable gate array is connected to the first memory and the second memory, the first memory is connected to the second memory, and a read speed of the first memory is greater than a read speed of the second memory.

The acquiring of the feature data may include: extracting the feature data from a data block of the at least one corresponding batch in the second memory to the first memory, based on the data block index of the data block.

The extracting of the feature data may include: determining the data block of the at least one corresponding batch from the second memory based on the data block index; and extracting the feature data of the determined data block into the first memory.

The transmitting of the feature data to the GPU may include: performing a preprocessing operation on the feature data extracted into the first memory; and transmitting the feature data after the preprocessing from the first memory to the GPU.

The extracting of the feature data may include: replacing feature data in the first memory that meets a data replacement condition with the feature data of the determined data block.

The data replacement condition may include at least one of following conditions: a utilization rate being below a predetermined value, a storage time exceeding a threshold, and the feature data not being used for a predetermined period of time.

The first memory may include a dynamic random access memory (DRAM), and the second memory may include a not-and (NAND) flash memory.

The acquiring of the feature data may include: based on the data block index, acquiring from the first memory, the feature data prefetched from the second memory to the first memory.

In one or more embodiments, there is provided a non-transitory computer-readable storage medium storing one or more instructions that, when executed by at least one processor, implements the method of training the graph neural network, performed by the memory expansion device.

In one or more embodiments, there is provided a device of training a graph neural network, the device including at least one processor configured to: determine at least one batch of training data; transmit batch information corresponding to the determined at least one batch to at least one memory expansion device, so that the at least one memory expansion device acquires feature data for one or more data blocks of the at least one batch based on the batch information; receive the feature data from the at least one memory expansion device; and train the graph neural network based on the feature data.

The at least one processor is further configured to: acquire an identity that includes an identifier and a data block index corresponding to the at least one batch; and generate the batch information including the identifier and the data block index associated with the at least one batch.

The at least one batch is included in a plurality of batches, and the at least one memory expansion device is included in a plurality of memory expansion devices, wherein the at least one processor is further configured to: transmit information of corresponding batches among the plurality of batches to corresponding memory expansion devices among the plurality of memory expansion devices, respectively.

The at least one processor is further configured to: acquire resource utilization rates of the plurality of memory expansion devices; determine a data quantity of the at least one batch transmitted to each of the plurality of memory expansion devices based on the resource utilization rate; determine an allocation result for allocating the plurality of batches to the plurality of memory expansion devices based on the data quantity; and transmit the plurality of batches based on the allocation result.

The at least one processor is further configured to: sequentially place the feature data into a training queue based on the identity; and train the graph neural network based on a sequence of the feature data in the training queue.

The memory expansion device may include a first memory, a second memory, and a field programmable gate array.

In one or more embodiments, there is provided a device of training a graph neural network, the device including at least one processor configured to: receive batch information indicating at least one batch of training data transmitted by a graphics processing unit (GPU); determine at least one corresponding batch among a plurality of batches of training data based on the batch information; acquire feature data of the at least one corresponding batch; and transmit the feature data to the GPU so that the GPU trains the graph neural network using the feature data.

The at least one processor is further configured to: determine an identity for each of the at least one corresponding batch based on the batch information, wherein the identity includes an identifier and a data block index corresponding to the at least one batch; and determine the at least one corresponding batch based on the identifier.

The device may include a first memory, a second memory, wherein the at least one processor includes a field programmable gate array.

The field programmable gate array is connected to the first memory and the second memory, the first memory is connected to the second memory, and a read speed of the first memory is greater than a read speed of the second memory.

The at least one processor may include further configured to: extract the feature data from a data block of the at least one corresponding batch in the second memory to the first memory based on the data block index of the data block.

The at least one processor is further configured to: determine the data block of the at least one corresponding batch from the second memory based on the data block index; and extract the feature data of the determined data block into the first memory.

The at least one processor is further configured to: perform a preprocessing operation on the feature data extracted into the first memory; and transmit the feature data after the preprocessing from the first memory to the GPU.

The at least one processor is further configured to: replace feature data in the first memory that meets a data replacement condition with the feature data of the determined data bock.

The data replacement condition may include at least one of following conditions: a utilization rate being below a predetermined value, a storage time exceeding a threshold, and the feature data not being used for a predetermined period of time.

The first memory may include a dynamic random access memory (DRAM), and the second memory may include a not-and (NAND) flash memory.

The at least one processor is further configured to: based on the data block index, acquire from the first memory, the feature data prefetched from the second memory to the first memory.

The method of training a graph neural network performed by a GPU according to one or more example embodiments of the present disclosure, by determining batch information for training data, wherein the batch information includes information of at least one batch of the training data, sending the batch information to at least one memory expansion device, so that the at least one memory expansion device acquires feature data for data block(s) of the at least one batch according to the received information of the at least one batch, receiving the feature data for the data block(s) of the at least one batch sent by the at least one memory expansion device, and training the graph neural network based on the feature data, the training speed of the graph neural network is improved, while the training accuracy of the graph neural network is maintained.

The method of training a graph neural network performed by a memory expansion device according to one or more example embodiments of the present disclosure, by receiving information of at least one batch sent by a GPU, determining corresponding batch(es) among a plurality of batches of training data based on the information of the at least one batch, acquiring feature data for data block(s) of the corresponding batch(es), and sending the feature data to the GPU, so that the GPU trains the graph neural network using the feature data, the training speed of the graph neural network is improved, while the training accuracy of the graph neural network is maintained.

Although the present disclosure has been specifically shown and described with reference to one or more example embodiments thereof, those skilled in the art should understand that various changes of the forms and details may be made without departing from the spirit and scope of the present disclosure as defined by the claims.

What is claimed is:

1. A method of training a graph neural network, performed by a memory expansion device, wherein the method comprises:
receiving batch information indicating at least one batch of training data transmitted a graphics processing unit (GPU);
determining at least one corresponding batch among a plurality of batches of training data based on the batch information;
acquiring feature data of the at least one corresponding batch; and
transmitting the feature data to the GPU, so that the GPU trains the graph neural network using the feature data.

2. The method according to claim 6, wherein the determining of the at least one corresponding batch comprises:
determining an identity for each of the at least one corresponding batch based on the batch information, wherein the identity comprises an identifier and a data block index corresponding to the at least one batch; and
determining the at least one corresponding batch based on the identifier.

3. The method according to claim 7, wherein the memory expansion device comprises a first memory, a second memory, and a field programmable gate array.

4. The method according to claim 3, wherein the field programmable gate array is connected to the first memory and the second memory, the first memory is connected to the second memory, and a read speed of the first memory is greater than a read speed of the second memory.

5. The method according to claim 3, wherein the acquiring of the feature data comprises:
extracting the feature data from a data block of the at least one corresponding batch in the second memory to the first memory, based on the data block index of the data block.

6. The method according to claim 5, wherein the extracting of the feature data comprises:
determining the data block of the at least one corresponding batch from the second memory based on the data block index; and
extracting the feature data of the determined data block into the first memory.

7. The method according to claim 3, wherein the transmitting of the feature data to the GPU comprises:
performing a preprocessing operation on the feature data extracted into the first memory; and
transmitting the feature data after the preprocessing from the first memory to the GPU.

8. The method according to claim 6, wherein the extracting of the feature data comprises:
replacing feature data in the first memory that meets a data replacement condition with the feature data of the determined data block.

9. The method according to claim 8, wherein the data replacement condition comprises at least one of following conditions: a utilization rate being below a predetermined value, a storage time exceeding a threshold, and the feature data not being used for a predetermined period of time.

10. The method according to claim 5, wherein the first memory comprises a dynamic random access memory (DRAM), and the second memory comprises a not-and (NAND) flash memory.

11. The method according to claim 3, wherein the acquiring of the feature data comprises:
based on the data block index, acquiring from the first memory, the feature data prefetched from the second memory to the first memory.

12. A device of training a graph neural network, the device comprising at least one processor configured to:
receive batch information indicating at least one batch of training data transmitted by a graphics processing unit (GPU);
determine at least one corresponding batch among a plurality of batches of training data based on the batch information;
acquire feature data of the at least one corresponding batch; and
transmit the feature data to the GPU, so that the GPU trains the graph neural network using the feature data.

13. The device according to claim 12, wherein the at least one processor is further configured to:
determine an identity for each of the at least one corresponding batch based on the batch information, wherein the identity comprises an identifier and a data block index corresponding to the at least one batch; and
determine the at least one corresponding batch based on the identifier.

14. The device according to claim 13, further comprising a first memory, a second memory,
wherein the at least one processor includes a field programmable gate array.

15. The device according to claim 14, wherein the field programmable gate array is connected to the first memory and the second memory, the first memory is connected to the second memory, and a read speed of the first memory is greater than a read speed of the second memory.

16. The device according to claim 14, wherein the at least one processor is further configured to:
extract the feature data from a data block of the at least one corresponding batch in the second memory to the first memory based on the data block index of the data block.

17. The device according to claim 16, wherein the at least one processor is further configured to:
determine the data block of the at least one corresponding batch from the second memory based on the data block index; and
extract the feature data of the determined data block into the first memory.

18. The device according to claim 14, wherein the at least one processor is further configured to:
perform a preprocessing operation on the feature data extracted into the first memory; and
transmit the feature data after the preprocessing from the first memory to the GPU.

19. The device according to claim 17, wherein the at least one processor is further configured to:
replace feature data in the first memory that meets a data replacement condition with the feature data of the determined data bock.

20. A non-transitory computer-readable storage medium storing one or more instructions that, when executed by at least one processor, implement the method of training the graph neural network of claim 1.
